(19) United States
(12) Patent Application Publication
(10) Pub. No.: US 2004/0007850 A1
(43) Pub. Date: Jan. 15, 2004

(54) Headset for bicycles, cycles and the like

(76) Inventors: Raymond Crozet, Saint Etienne (FR); Michel Jaligot, Saint Chamod (FR)

Correspondence Address: HESLIN ROTHENBERG FARLEY & MESITI PC, 5 COLUMBIA CIRCLE, ALBANY, NY, 12203, US

(21) Appl. No.: 10/601,362

(22) Filed: Jun. 23, 2003

(30) Foreign Application Priority Data
Jun. 28, 2002 (FR) 0208273

(51) Int. Cl. B62K 21/00

(52) U.S. Cl. 280/280

(57) ABSTRACT

The headset for bicycles, cycles and the like of the type comprising, in a one-piece cartridge, a bearing assembly (3) inserted between an outer cup (2) and an inner cup (4), the outer cup bearing against the interior wall of a bore in the head tube, is notable in that it comprises, as one piece,said cartridge including a floating reinforced seal, on which there is positioned a ring which itself on the outside has a seal bearing against the outer cup,said ring being in contact with the inner cup of the cartridge, the ring housing, in its upper part, an O-ring and a compression ring in order to give compression stresses.

The invention relates to the technical field of components for cycles, bicycles and more particularly to headsets used especially in the head tube—fork pivot and handlebar support bracket assembly.

The design of headsets to adapt and orient the handlebar stem relative to the head tube, in particular, has evolved a great deal for purposes of simplification and of reducing the number of components. Units known as cartridges containing, as a one piece assembly, the needle or ball bearing assemblies and the outer and inner bearing cups are currently available on the market, this unit then being positioned either in the conical accommodating bore of the head tube or in dishes of cylindrical exterior profile and conical interior profile pushed into the head tube and then entailing the fitting of additional attached clamping elements.

The problem nonetheless lies in the difficulty of adjusting the position of the cartridges located on each side of the ends of the head tube, where there is very often a problem of misalignment, which means that this may lead to damage to the seals through wear and contact, or to play appearing.

Another problem posed in the prior art lies in the search for simplification during assembly and for a reduction in the number of parts involved in a headset assembly.

These characteristics and others yet will become clearly apparent from the remainder of the description.

According to a first characteristic of the invention, the headset for bicycles, cycles and the like of the type comprising, in a one-piece cartridge, a bearing assembly inserted between an outer cup and an inner cup, the outer cup bearing against the interior wall of a bore in the head tube, is notable in that it comprises, as one piece, said cartridge including a floating reinforced seal, on which there is positioned a ring which itself on the outside has a seal bearing against the outer cup, said ring being in contact with the inner cup of the cartridge, the ring housing, in its upper part, an O-ring and a compression ring in order to give compression stresses.

According to another characteristic, the outer cup is designed on its interior wall to have a cut-out allowing a profiled seal to float and housing an insert to compensate for misalignment of the contact regions.

These characteristics and others yet will become clearly apparent from the remainder of the description.

In order to place the subject of the invention illustrated nonlimitingly in the figures of the drawing where:

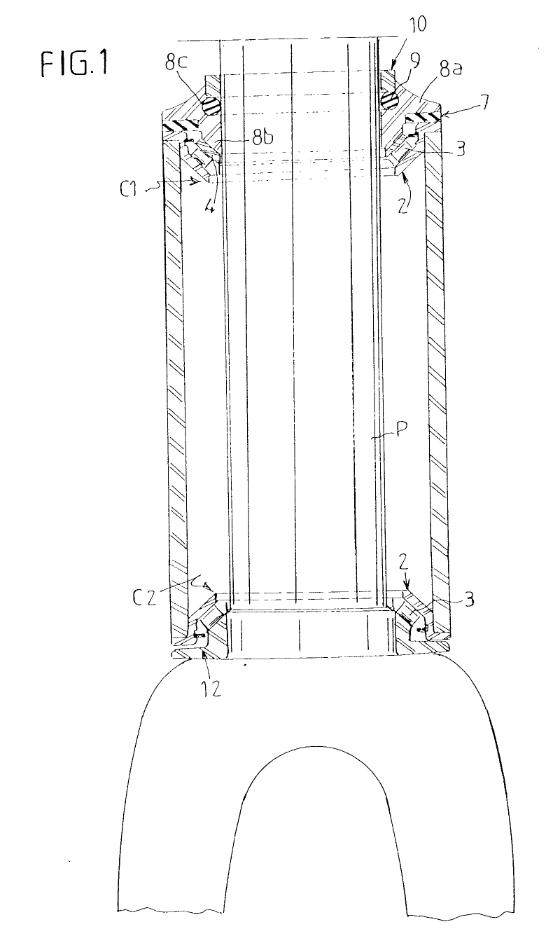

FIG. 1 is a view in longitudinal section of a head tube that can accommodate two headsets according to the invention, an upper one and a lower one.

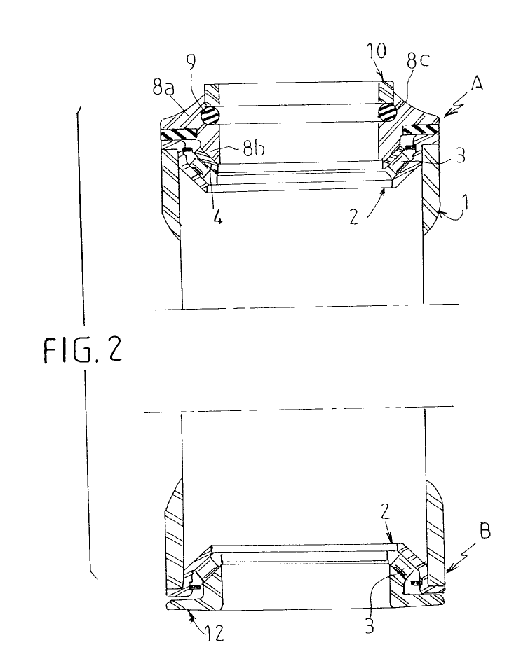

FIG. 2 is a part view in section on a larger scale illustrating the positioning of the upper and lower cartridges of the headsets.

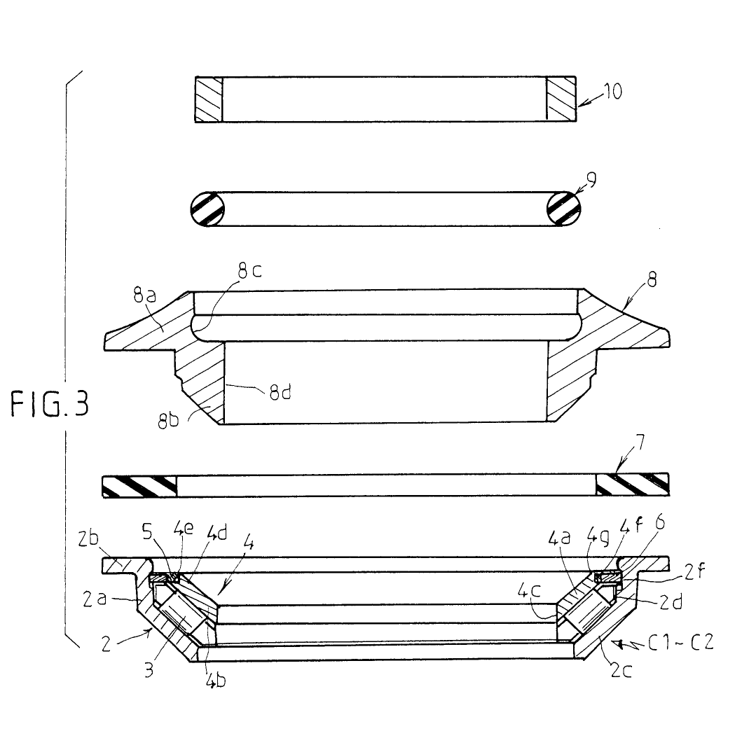

FIG. 3 is an exploded part view prior to the mounting of the upper headset.

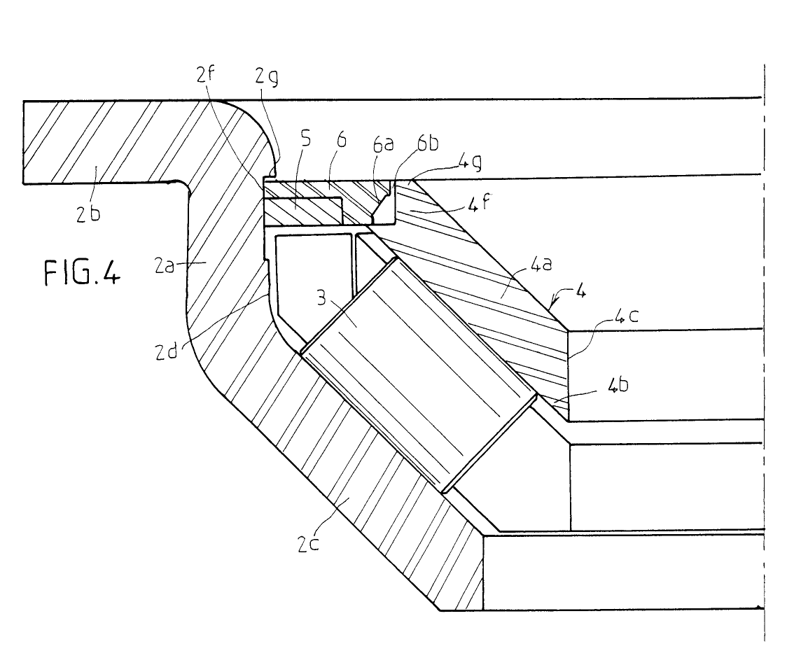

FIG. 4 is a part view zooming in on half of part of the upper headset.

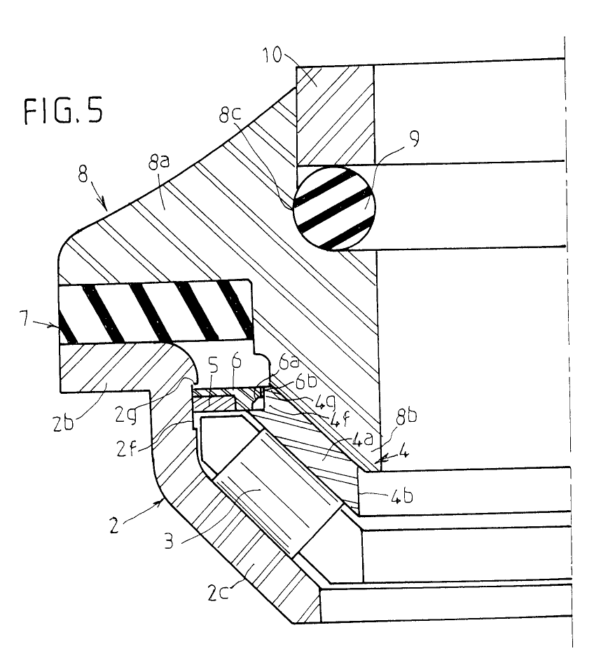

FIG. 5 is a part view zooming in on FIG. 4 to illustrate the mounted assembly, with the ring, the O-ring and the compression ring.

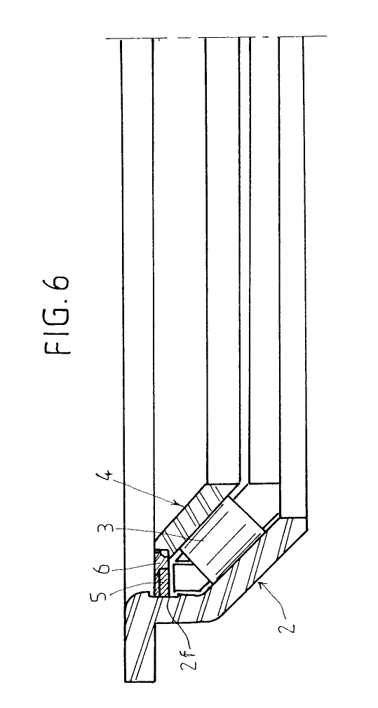

FIG. 6 is a part view zooming in on half of the cartridge in the bottom part of the head tube intended to be positioned.

In order to give a more concrete idea of the subject of the invention, it is now described in a nonlimiting manner illustrated in the figures of the drawings.

The reference (1) denotes a head tube for bicycles and the like, able to accommodate, in each of its ends, a headset (A-B) in their general identification, allowing the insertion of a fork pivot. Each headset is designed to include a profiled cartridge (C1-C2) able to be force-fitted inside the bore of the head tube. According to the invention, the two cartridges are identical, which means that just one of them will be described.

Each cartridge comprises a profiled outer cup (2) with a peripheral cylindrical wall (2a) able to be forcibly inserted into the bore of the head tube, said wall being extended at the top with a peripheral horizontal part (2b) forming a flange bearing against the end edge of the head tube. The cylindrical wall (2a) is extended downward in the form of a conical wall (2c) directed inwards, constituting the seat for the needle bearings (3). The inner cup (4) has a conical profile (4a) with a bottom end (4b), a straight and vertical flat wall (4c) parallel to the longitudinal axis of the headset. The top end (4d) has a cut (4e) the function of which will become evident later. The top plane (4f) of the cup adjacent to said cut is straight and horizontal. A profiled peripheral seal (5) reinforced with a core or insert (6) made of brass or some other material is placed resting against the interior wall (2d) of the outer cup, and the wall opposite of the inner cup. More specifically, the interior wall of the outer cup is designed with a cut-out or recess (2f) made over part of its height over a distance greater than the thickness of the seal reinforced with the insert. This brass insert stiffens the assembly. The seal with insert thus rests against an internal face of the wall (2a) of the outer cup, at the position of the cut-out and bearing against a nose-like end part (4g) of the inner cup. The seal (5) with insert (6) has, on the inner cup side, an oblique face (6a) and its interior edge face (6b) is not in contact with the profile opposite belonging to the inner cup. The seal with insert thus floats in the space formed, defined above, so that it allows correction of alignment of the regions of contact with the fork pivot (P).Said seal is clipped into its housing and held in position by the nose-forming end part (2g) of the aforementioned cut-out (2f) forming a stop.

The assembly thus defined constitutes the cartridge.

The headset is then supplemented by its upper front part with a seal (7) and an upper ring (8) which has a flange (8a) pressing against the seal (7), and a lower profile (8b) bearing as a reference on the aforementioned inner cup. The ring (8) has a bore (8d) and slides on the outside of the fork pivot. The ring sits, as a reference bearing, against the cartridge lower cup facing wall. The ring (8) is thus configured in its top plane with a recess (8c) to house an O-ring (9) and a compression ring (10) completing the guidance of the fork pivot. Similarly, in the lower part, the headtube takes a cartridge which also comprises a seal with insert, arranged between the lower and upper cups in the same configuration as before, and a ring (12) pressing against the interior face of the inner cup.

The headset thus produced offers great advantages: it is easy to assemble, with a low number of parts, and also very advantageously allows the alignment of the regions of contact and of abutment with the fork pivot to be corrected. The connection is thus improved and the user finds better comfort in the use of this assembly. The lower headset includes the cartridge (C2) depicted in FIG. 6 and has substantially the same arrangement.

In the claims:

1. (Currently Amended) Headset for bicycles, cycles and the like of the type comprising, in a one-piece cartridge, a bearing assembly (3) inserted between an outer cup (2) and an inner cup (4), the outer cup bearing against the an interior wall of a bore in the a head tube, characterized in that it comprises, as one piece, wherein said cartridge including includes a floating reinforced seal, on which said seal there is positioned a ring which itself ring on the an outside has a seal bearing against the outer cup, said ring being in contact with the inner cup of the cartridge, the a ring housing, in its an upper part, an O-ring and a compression ring in order to give compression stresses.

2. (Currently Amended) Headset according to claim claim 1, characterized in that wherein the outer cup has is designed on its interior wall (2d) to have a cut-out on an interior wall (2f) allowing a profiled seal (5) to float and housing an insert (6) to compensate for misalignment of the contact regions.

3. (Currently Amended) Headset according to either one of claims 1 and 2 claim 1, wherein characterized in that the outer cup comprises a cylindrical wall (2a) force-fitting into the head tube, continued in an the upper part by a horizontal part (2b) forming a flange and by a conical lower wall (2c) directed inwards and forming the a seat for the bearings.

4. (Currently Amended) Headset according to either one of claims 1 and 3 claim 1, characterized in that wherein the inner cup (4) has a conical profile (4a) with a bottom part (4b) and a vertical straight wall (4e), the an upper end (4d) having a cut (4e), the an upper plane (4f) of the inner cup adjacent to said cut being straight and horizontal and exhibiting a nose (4g) on which the seal (5) rests.

5. (Currently Amended) Headset according to claim claim 2, characterized in that wherein the seal (5) is mounted to float in the cut-out (2f) formed on the profile of the outer cup and in that the cut-out (2f) is made over part of the a height of the a wall of said outer cup over a distance greater then the a thickness of the seal which is mounted and positioned by clipping, said seal being mounted in the cut-out (2f) while being held in place with the nose part forming a stop.

6. (Currently Amended) Headset according to claim claim 5, characterized in that wherein the seal has an insert.

7. (Currently Amended) Headset according to claim claim 6, characterized in that wherein the inset insert is made of brass.

8. (Currently Amended) Headset for bicycles, cycles and the like of the type comprising, in a one-piece cartridge, a bearing assembly (3) inserted between an outer cup (2) and an inner cup (4), the outer cup bearing against the an interior wall of a bore in the a head tube, characterized in that it comprises, as one piece, wherein said cartridge including includes a floating reinforced seal, on which said seal there is positioned a ring which itself ring on the an outside has a seal bearing against the outer cup, said ring being in contact with the inner cup of the cartridge.
